(19) United States
(12) Patent Application Publication
(10) Pub. No.: US 2022/0330517 A1
(43) Pub. Date: Oct. 20, 2022

(54) TRANSPORT CAGE FOR ANIMALS

(71) Applicant: MP Group nv, Izegem (BE)

(72) Inventor: Sabine GEVAERT, Bredene (BE)

(21) Appl. No.: 17/845,588

(22) Filed: Jun. 21, 2022

Related U.S. Application Data
(63) Continuation-in-part of application No. 29/732,983, filed on Apr. 29, 2020.

(51) Int. Cl. A01K 1/02

(52) U.S. Cl. CPC A01K 1/0245

(57) ABSTRACT

The present disclosure relates to a transport cage for animals, comprising an upper part and lower part which are manufactured from plastic, wherein the lower part comprises a bottom part which is delimited by a peripheral wall, and wherein the upper part and lower part are fastened to one another and form a closed space for accommodating an animal, wherein the bottom part comprises at least one zone having a wall thickness that is at least 1.4 times thicker than the wall thickness of the peripheral wall.

### FIELD OF THE DISCLOSURE

The present disclosure relates, firstly, to a transport cage for animals, preferably pets, comprising an upper part and lower part which are manufactured from plastic, wherein the lower part comprises a bottom part which is delimited by a peripheral wall, and wherein the upper part and lower part are fastened to one another and form a closed space for accommodating an animal. The transport cage according to embodiments of the present disclosure is particularly suitable for being taken onto an aircraft.

Secondly, the present invention relates to a method for forming such a transport cage.

### BACKGROUND

Conventional (animal) cages are known and exist in all kinds of shapes and dimensions. The most common cages have a rectangular shape and are manufactured from plastic or metal. However, they have the disadvantage that, during transport, specifically transport by aircraft, they often get damaged due to excessively rough treatment during the transport, such as for example in the case of dragging of the cages or as a result of specific movements of the transport vehicle during the transport.

### SUMMARY

The object of embodiments of the present disclosure is therefore to provide a transport cage which will get damaged less rapidly, specifically due to excessively rough treatment thereof during the transport.

The object of embodiments of the disclosure is achieved by providing a transport cage for animals, comprising an upper part and lower part which are manufactured from plastic, wherein the lower part comprises a bottom part which is delimited by a peripheral wall, and wherein the upper part and lower part are fastened to one another and form a closed space for accommodating a pet, wherein the bottom part comprises at least one zone having a wall thickness that is at least 1.4 times thicker than the wall thickness of the peripheral wall. Preferably, said zone is at most two times thicker than the wall thickness of the peripheral wall. The side wall preferably has a thickness of 3 mm. The thicker zone in the bottom part preferably has a thickness of 6 mm. In particular, at least 50% of the surface of the bottom part is of thicker embodiment, preferably 55%-100% of the surface of the bottom part is of thicker embodiment, more particularly 65% of the surface of the bottom part is of thicker embodiment.

Embodying the bottom part, or in any case at least a part thereof, to be thicker will increase the stiffness of the transport cage. This will also improve the bending and impact resistance of the transport cage, as a result of which the latter will get damaged much less rapidly than the conventional cages during rough transport operations.

In a preferred embodiment of the transport cage according to the disclosure, the peripheral wall of the lower part comprises a rear wall and two side walls. The upper part preferably comprises a top wall which is delimited by a peripheral wall which comprises a rear wall and two side walls. The lower part and upper part have in particular the same shape and dimensions. It is also possible for the top wall to be embodied, in a similar manner to the bottom, so as to have a zone that is thicker than the adjoining side walls or rear wall.

In an advantageous embodiment of the transport cage according to the disclosure, at least one part of the side walls and/or the rear wall is perforated. The perforations ensure good air circulation. Instead of perforations, it is also possible for openings to be provided in the side walls and/or rear wall. The inner side and/or outer side of the transport cage may preferably be provided, at the location of the perforations or openings, with a perforated metal plate. This is done, for example, in order to make the cage suitable for transporting aggressive animals.

In a more advantageous embodiment of the transport cage according to the disclosure, the upper part and/or lower part comprise/comprises handles. The upper part and/or lower part preferably comprise/comprises two or four handles. By means of the handles, the transport cage can be moved easily by hand by one or two people.

In a preferred embodiment, the rear wall and/or side walls of the upper part and/or the lower part are/is further provided with supporting ribs which extend over the entire height of the rear wall and/or side walls. These supporting ribs provide additional stiffness. The supporting ribs in question are embodied in such a way that an external harness can be fastened thereto, by means of which the transport cage is fastenable against a vehicle, for example. Other accessories, such as feed containers with water or additional food, leashes, an identification element, may also be fastened against the outer periphery of the transport cage or against the harness.

The lower part and upper part are preferably connected to one another via a nut/bolt connection.

In a particular embodiment of the transport cage according to the disclosure, the transport cage comprises a door which is provided for closing the entrance to the closed space. The door is preferably embodied in the form of a grille and manufactured from metal (for example steel) bars. The door is preferably constructed from longitudinal and transverse bars which are connected to one another in a grille pattern by means of a welded connection. In an alternative embodiment, the door is embodied in a plate-shaped manner, preferably made of metal or plastic. The door is preferably located on the front side of the transport cage, and, to this end, the lower part and upper part of the transport cage have an open front side in a preferred embodiment.

According to a more particular embodiment of the transport cage according to the disclosure, the lower part and upper part are manufactured by thermoplastic foam moulding. Thermoplastic foam moulding is a technique derived from injection moulding. This involves also injecting a chemical or physical blowing agent, which ensures that the plastics product will foam in the mould, during the injection-moulding process. The lower part and upper part are preferably manufactured from polypropylene.

Another subject of embodiments of the present disclosure is a method for forming a transport cage for animals, comprising an upper part and lower part which are manufactured from plastic, wherein the lower part comprises a bottom part which is delimited by a peripheral wall, wherein the method comprises the following steps:
forming the lower part in a mould by thermoplastic foam moulding;
forming the upper part in a mould by thermoplastic foam moulding;
fastening the lower part and upper part to one another;
   wherein a removable forming element is fitted in the mould of the lower part, and wherein the forming element is removed from the mould after the foam has been applied in the mould, as a result of which the bottom part comprises a zone having a wall thickness that is at least 1.4 times thicker than the wall thickness of the peripheral wall. The method is in particular provided for manufacturing a transport cage according to the embodiments of the disclosure as described above.

### BRIEF DESCRIPTION OF THE DRAWINGS

The present invention will now be explained in more detail by means of the following description of a number of preferred embodiments of a transport cage according to embodiments of the present disclosure. The sole aim of this description is to give illustrative examples and to indicate further advantages and features of the system, and can thus by no means be interpreted as a limitation of the area of application of the invention or of the patent rights defined in the claims.

Reference numerals are used in this description to refer to the attached drawings, in which:

FIG. 1 shows a perspective illustration of a transport cage according to at least one embodiment of the disclosure;

FIG. 2 shows a perspective illustration of the transport cage shown in FIG. 1, in which the rear side is visible;

FIG. 3 shows an exploded illustration of the transport cage shown in FIGS. 1 and 2;

FIG. 4 shows a top view of the lower part of the transport cage, in which the hatched part illustrates the zone that is embodied to be thicker than the peripheral wall of the lower part;

FIG. 5 shows an illustration along section A-A in FIG. 4;

FIG. 6 shows a detail illustration of the area B circled in FIG. 5;

FIG. 7 shows an alternative illustration of a transport cage according to at least one embodiment of the disclosure, the latter being provided with a number of plate-shaped elements made of metal for strengthening purposes.

### DETAILED DESCRIPTION

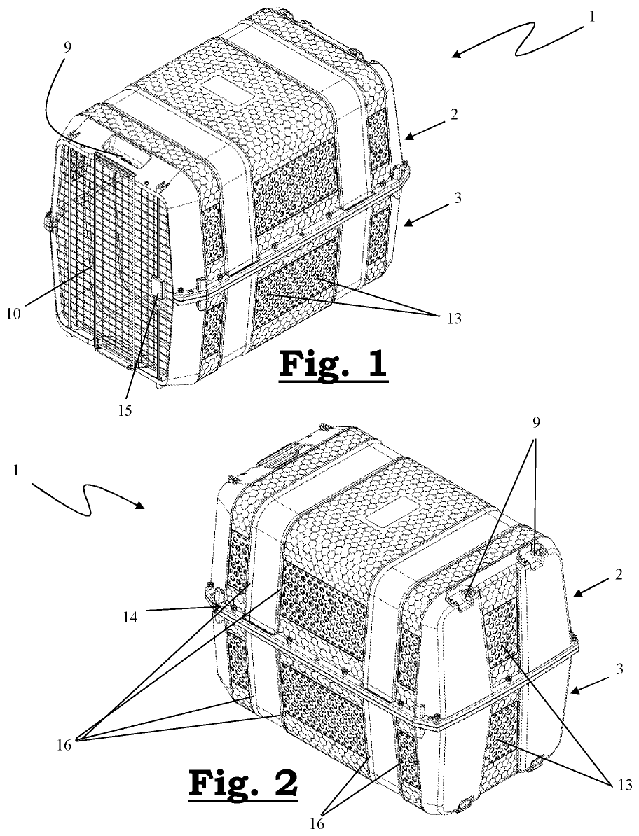

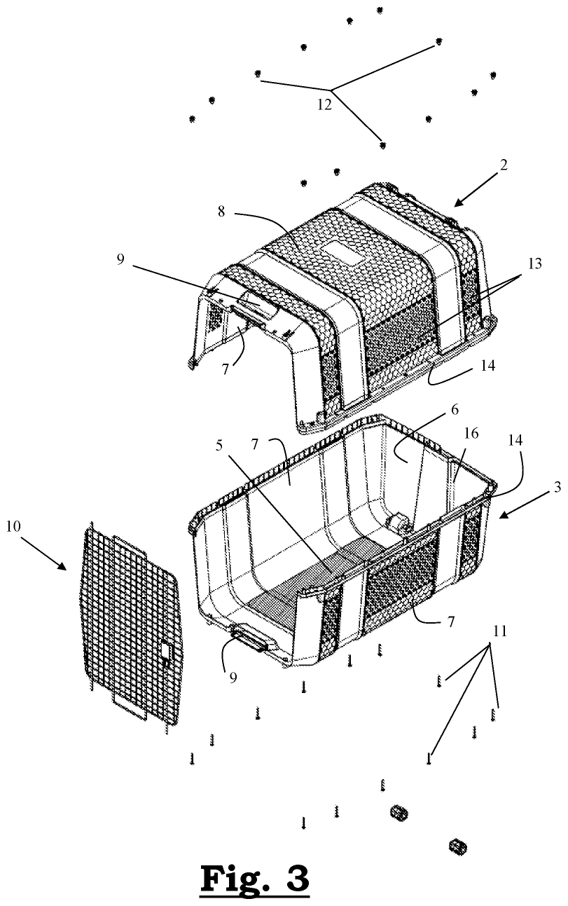

The transport cage (1) according to embodiments of the present disclosure and as illustrated in FIGS. 1 and 2 was developed, in particular, for both private individuals and professionals who wish to transport their animals, preferably pets, such as for example dogs and cats, or other animals, such as for example goats or wild animals, or want to bring them along when travelling. As can be seen from FIG. 3, the cage (1) comprises two parts that are similar in terms of shape, specifically a lower part (3) (shell) and an upper part (2) (shell). The two parts (2; 3) are secured to one another, preferably via bolts (11) and nuts (12), and define a closed space for accommodating an animal. The closed space may have any size that is suitable for one or more animals (pets). The dimensions of the cage (1) may be, for example, 49×31×21 cm, 59.5×39×40 cm, 91×61×66 cm, 115×69×85 cm or 135×80×95 cm (length×width×height).

The lower part (3) consists of a bottom part (4) (floor) which is delimited by a peripheral wall consisting of two vertical side walls (7) which are connected to one another via a rear wall (6). The front side of the lower part (3) is open. The upper part (2) consists of a top wall (8) (top part) which is delimited by a peripheral wall consisting of two downwardly directed side walls (7) which are connected to one another via a rear wall (6). In order to limit the internal stresses, the cage (1) is designed in such a way that there is a smooth transition between the side walls (7) and the bottom part (4) in the lower part (3), and there is a smooth transition between the side walls (7) and the top wall (8) in the upper part (2). The front side of the upper part (2) is also open and will form, together with the open front side of the lower part (3), the entrance opening to the closed space.

The lower part (3) and upper part (2) are made from plastic, preferably a foamed plastic, such as for example foamed polypropylene. Using plastic makes it possible to reduce the weight of the transport cage (1). In practice, depending on the dimensions, the transport cage (1) has a weight of between 0.5 kg and 15 kg, preferably a weight of between 5 kg and 12 kg.

As can be seen from the attached figures, part of the side walls (7) and rear walls (6) is perforated in order to thus create air openings (13) for better air circulation. The total ventilation surface is at least 16% of the total surface of the peripheral walls. Furthermore, both the lower part (3) and the upper part (2) are provided with a fastening edge (14) comprising passage openings for the bolts (11) which are used to connect the two parts (2; 3) to one another.

The entrance opening is closed by a door construction (10) which is preferably a grille structure manufactured from steel or another suitable material. The animal (pet) can be put into and taken out of the transport cage (1) via the entrance opening. The door (10) may be provided with a locking mechanism (15). In the interest of strength, preference is given to manufacturing a locking mechanism (15) from metal. It is of course also possible to opt for a locking mechanism (15) manufactured from plastic for economic reasons.

The transport cage (1) according to embodiments of the disclosure can be moved by one or two people. To this end, handles (9) are provided in the upper part (2) and/or lower part (3). A handle (9) is also provided above the entrance opening. The transport cage (1) may furthermore also be equipped with two or four wheels so as to be able to move the cage (1) more easily. These wheels are preferably also manufactured from plastic.

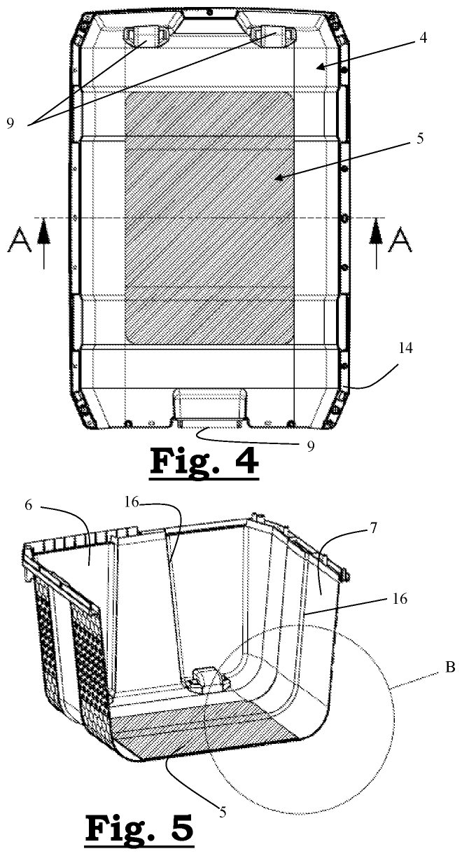

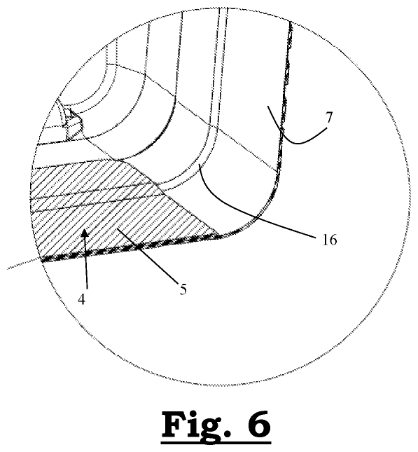

In order to afford sufficient stiffness/strength, the largest part of the bottom (4) is embodied to be thicker than the side walls (7). In the embodiments depicted, the side walls (7) have a wall thickness of 3 mm, and the zone in the bottom that is configured to be thicker (hatched area visible in FIGS. 3 to 6) has a wall thickness of 6 mm. If desired, it is also possible for a part of the top wall (8) of the upper part (2) to be embodied, in a similar manner as for the bottom, to be thicker than the side walls.

In order to provide additional stiffness, the rear wall (6) and/or side walls (7) of the upper part (2) and/or the lower part (3) are provided with supporting ribs (16) which extend over the entire height of the rear wall (6) and/or side walls (7). The supporting ribs (16) in question are embodied in such a way that an external harness can be fastened thereto, by means of which the transport cage (1) is fastenable against a vehicle, for example. Other accessories, such as feed containers with water or additional food, leashes, an identification element, may also be fastened against the outer periphery of the transport cage (1) or against the harness.

The lower part (3) and upper part (2) are formed in a mould by a thermoplastic foam-moulding process. In order to be able to embody the bottom part (4), or in any case at least a part thereof, of the lower part (3) to be thicker, the mould in question is provided with a retractable core (forming element). In this way, the local wall thickness in a specific zone can be doubled. The cell structure in the thicker zone (5) of the bottom part (4) will ensure a greater impact resistance.

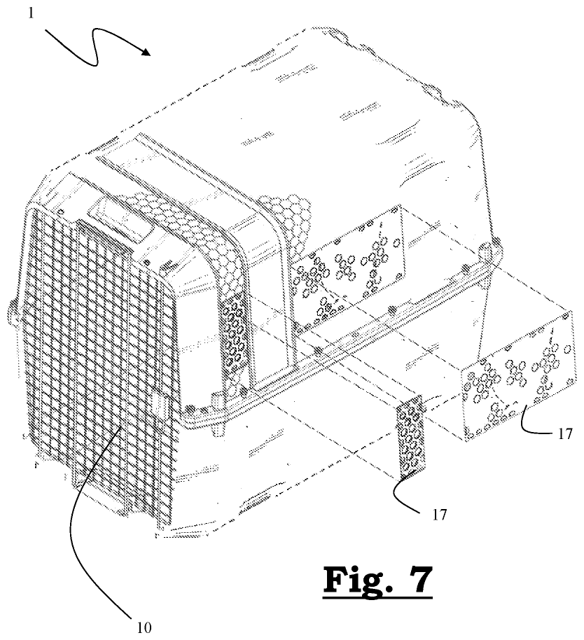

For strengthening purposes, as illustrated in FIG. 7, the transport cage may also be provided with one or more metal plate elements (17). The plate elements (17) may comprise no cutouts, but in the interest of air circulation, plate elements are preferably provided with a number of perforations which will form air openings. To this end, the transport cage may be provided with suitable cutouts in which these plate elements are placeable. These plate elements are fittable against the transport cage via fastening means or fastening methods suitable therefor. The fastening may be effected via a nut/bolt connection, via rivets, via screws or another known technique.

1. Transport cage for animals, comprising an upper part and lower part which are manufactured from plastic, wherein the lower part comprises a bottom part which is delimited by a peripheral wall, and wherein the upper part and lower part are fastened to one another and form a closed space for accommodating an animal, wherein the bottom part comprises at least one zone having a wall thickness that is at least 1.4 times thicker than the wall thickness of the peripheral wall.

2. Transport cage according to claim 1, wherein said zone is at most two times thicker than the wall thickness of the peripheral wall.

3. Transport cage according to claim 1, wherein the peripheral wall of the lower part comprises a rear wall and two side walls.

4. Transport cage according to claim 1, wherein the upper part comprises a top wall which is delimited by a peripheral wall which comprises a rear wall and two side walls.

5. Transport cage according to claim 3, wherein at least one part of the side walls and/or rear wall is perforated.

6. Transport cage according to claim 1, wherein the lower part and upper part have the same shape and dimensions.

7. Transport cage according to claim 1, wherein the upper part and/or lower part comprise/comprises handles.

8. Transport cage according to claim 1, wherein the lower part and upper part are connected to one another via a nut/bolt connection.

9. Transport cage according to claim 1, wherein the transport cage comprises a door which is provided for closing the entrance to the closed space.

10. Transport cage according to claim 1, wherein the lower part and upper part are manufactured by thermoplastic foam moulding.

11. Method for forming a transport cage for animals, comprising an upper part and lower part which are manufactured from plastic, wherein the lower part comprises a bottom part which is delimited by a peripheral wall, wherein the method comprises the following steps:
forming the lower part in a mould by thermoplastic foam moulding;
forming the upper part in a mould by thermoplastic foam moulding;
fastening the lower part and upper part to one another;
wherein a removable forming element is fitted in the mould of the lower part, wherein the forming element is removed from the mould after the foam has been applied in the mould, as a result of which the bottom part comprises a zone having a wall thickness that is at least 1.4 times thicker than the wall thickness of the peripheral wall.

12. Method according to claim 11, wherein the method is provided for manufacturing a transport cage comprising an upper part and lower part which are manufactured from plastic, wherein the lower part comprises a bottom part which is delimited by a peripheral wall, and wherein the upper part and lower part are fastened to one another and form a closed space for accommodating an animal, wherein the bottom part comprises at least one zone having a wall thickness that is at least 1.4 times thicker than the wall thickness of the peripheral wall and that is at most two times thicker than the wall thickness of the peripheral wall.
